(19) United States
(12) Patent Application Publication
(10) Pub. No.: US 2006/0059086 A1
(43) Pub. Date: Mar. 16, 2006

(54) Computer system and method for marketing and making loans to individuals for retirement savings

(76) Inventor: Michael Mulhern, Annapolis, MD (US)

Correspondence Address: DEWITT ROGGIN PLLC, 12 E. LAKE DRIVE, ANNAPOLIS, MD, 21403, US

(21) Appl. No.: 11/226,083

(22) Filed: Sep. 14, 2005

Related U.S. Application Data
(60) Provisional application No. 60/609,698, filed on Sep. 14, 2004.

(51) Int. Cl. G06Q 40/00

(52) U.S. Cl. 705/38

(57) ABSTRACT

A computer-based system and method administering and marketing a tax-advantaged loan program to loan consumers, plan administrators, and employers and method for lending money to employees based on their individual contributions to pension vehicles is disclosed. The system includes the use of computers and computer programs for marketing, underwriting, initiation, calculating periodic loan amounts, funding, monitoring, storing data, processing, and administration of loans designed to increase employee retirement savings with the loan costs being offset by tax savings. The loans may be made for any period of time and may be repaid based on the repayment capability of individual borrowers, subject of credit considerations and term limitations.

### CROSS-REFERENCE TO RELATED APPLICATIONS

The present application claims the benefit of the filing date of U.S. Provisional Patent Application Ser. No. 60/609,698, entitled “Computer system and Method for Marketing and Making Loans to Individuals for Retirement Savings” and filed on Sep. 14, 2004 by inventor Michael Mulhern.

The above cross-referenced related application is hereby incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to the field of computer systems and methods for providing loans to individuals.

2. Brief Description of the Related Art

Since their inception in the late 70s and early 80s, 401(k) and other defined-contribution (DC) plans have multiplied significantly. Over the past 25 years the number of employees who participate in such plans grew from about 15 million to over 60 million today. This is largely the result of companies migrating from defined-benefit (DB) plans, shifting the burden of retirement savings to employees, and offering only DC plans. The share of U.S. workers covered by just a DC plan has grown to 60% whereas 25 years ago the opposite was true, 60% of employees were covered by a DB plan, sponsored by and funded by their employer. These plans (including 401(k) and similar 403(b) and 457 plans) have quickly exceeded the level of investments in defined-benefit plans, where the employer is responsible for the retirement earnings of the pensioners. Many corporate, government, not-for-profit and other entities offer DC plans that allow employers to withhold amounts from employees' periodic payroll (per percentages as directed by individual employees) to be invested in various plan assets, as allowed by the employer-specific DC plan and as selected (among the investments offered) by individual employees.

While many working Americans recognize the need to invest and forego current cash flow to make contributions to their retirement plans early in their working careers, a great majority of employees either do not participate at all or under invest. Those who do participate fully tend to be those who are older and better compensated.

The DC business is significant, reaching over $2 trillion in assets and exceeding assets of DB plans. The chart below illustrates the size of the various types of defined contribution plans as the end of 2002.

| | Total Assets |
|---|---|
| Defined Contribution Plan Type | (in millions) |
| Corporate 401(k) | $965,432 |
| Other 401(k) | $42,434 |
| 457 | $41,763 |
| 403(b) | $382,640 |
| Other | $359,023 |

Similarly, other tax-advantaged retirement investments, including IRAs and Keoghs, have grown significantly since their inception. The IRS reported that the number of returns that included tax-advantaged IRA contributions increased from 1.2 million in 1975 to 3.5 million in 2000. Similarly, the amount invested in these retirement accounts increased from $1.4 billion in 1975 to $7.5 billion in 2000. Like the DC plans sited above, however, much of these investments are coming from the same demographic group, those who are older and more financially secure. Less than 10% of traditional IRA owners at under age 35. As with DC participation, earlier investment in IRAs has a dramatic impact on the level of investment available for retirement.

Many in the workforce do not participate at all in these plans (at least 30% of eligible employees do not participate in a 401(k) plan at all). Even among those who do participate, many are woefully under investing relative to what is allowed by law and relative to the amount they need to secure a healthy retirement. The Principal Financial (a leading DC administrator, with 1.9 million participants) indicates that the average deferral rate (share of salary) was 6.5% in 2002, but was just 5.1% for those employees between the ages of 25-34. While the IRS currently allows contributions of $13,000 per year (the legal limit increases periodically), lesser-paid employees are saving at rates far below what they potentially could contribute to their accounts. Estimates are that those making less than $30,000 are investing just over $1000 annually, on average, and those making between $30,000 and $50,000 are contributing under $3000 per year. Even at the higher income level of $50,000 to $75,000, workers are contributing on average just $4000, less than one third the amount allowed by law. Those in these last two income brackets sited, clearly many of whom are credit worthy, are, therefore, paying taxes in the current year on earnings averaging $9000-$10,000 that otherwise would not be taxed until retirement, often 30-40 years out. Note that these investment rates represent averages only for those who participate; they do not account for the large number of employees who do not participate in the plan at all.

The result is that American employees are not only under investing, but they are leaving a significant amount of potential tax deferrals on the table. A conservative estimate of the amount of tax-advantaged retirement savings that are available by law, but that are not being contributed is over $500 billion annually. The present invention is aimed at closing that gap.

A previous effort to provide a loan system for funding a pension or other retirement vehicle is disclosed in U.S. Pat. No. 5,903,879 to Mitchell. While that patent discloses a loan that is directed to funding a retirement account, the disclosed systems and methods lack flexibility because they deliberately avoid involvement of the employer and because they do not take into account variations in pay from pay period to pay period. Among other things, the present invention overcomes that lack of flexibility in previously suggested systems and methods.

### SUMMARY OF THE INVENTION

The present invention uses the tax-savings generated by contributions to certain qualified pensions made by individuals whereby the reduction in taxes due in the current period allows for borrowing of a portion (or all) of these contributions, accelerating additions to DC and other retirement savings vehicles, enhancing the level of periodic investments, and increasing the amount of retirement savings of individuals. The fundamental concept behind the invention is to use the tax deferment and savings to fund the retirement savings and the use of computers and computer programs and processes to approve, monitor, administer and process the loans. Note: tax deferrals and tax savings are, in the short term, synonymous as the taxpayer is not required to pay taxes on wages contributed to pension accounts until retirement, therefore reducing the current tax burden.

The target market for this invention is the vast number of employees in the United States who are either underfunding or not participating at all in employer-sponsored DC plans or other individual retirement plans, such as IRAs. Currently experts are predicting that a large share of the more that 77 million baby boomers who will be retiring over the next two decades will not have the level of savings and retirement plans that they had hoped for. This should fuel the need for increased participation early in one's career. This invention targets undersaving workers from their mid-20s through their 40s, although there is no age limitation. While it is likely that many will be salaried workers, there are also many workers who, for various reasons, have a time-lag in their pension funding ability. This invention provides an ideal way to bridge the funding gap. For example, many are paid periodic bonuses (e.g., semi-annually or annually). This invention would allow for contributions based on total compensation rather than just the base salary percentage (funding can make up for the short-term shortfall in compensation, allowing an employee to contribute his/her full amount without significantly affecting take-home pay). Similarly, often new partners in professional services (consulting, audit) firms, law firms and other similar firms often receive a nominal “draw” on partnership earnings in the first few years of partnership. Periodically, they are paid their full compensation, but that is often too late for current year contributions. This invention would be an ideal way to allow these professionals to contribute to their retirement plans in those periods where take-home pay is reduced.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention.

Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRITION OF THE DRAWINGS

For a more complete understanding of the present invention and the advantages thereof, reference is now made to the following description and the accompanying drawings, in which:

FIG. 1 is an organizational flow chart illustrating interaction among participants in a lending process in accordance with a preferred embodiment of the invention.

FIG. 2 is a table illustrating data produced by an embodiment of the present invention for modeling tax benefits (and the benefits of early investing) of a pension loan program.

FIG. 3 is a table illustrating data produced by an embodiment of the present invention for modeling individual cash flows.

FIG. 4 is a flow diagram illustrating interaction of participants in an underwriting process in accordance with the present invention.

FIG. 5 is a flow chart illustrating a method of administering a loan program in accordance with an embodiment of the invention.

FIG. 6 is a block diagram depicting an example of some of the computer systems housed in the various parties who would be part of this invention as well as communication lines and interfaces.

### DETAILED DESCRIPTION OF THE PREFERRED EMBODIMENTS

The present invention is believed to be both financially viable and in the public interest. The federal government, by approving the tax-deferred status of defined contribution and other pre-tax savings vehicles, is encouraging individual savings for retirement and transferring at least some of the burden of retirement planning away from the Social Security system. Further, government-guaranteed pension benefits, through the Pension Benefit Guaranty Corporation (PBGC), have become severely taxed of late, with many heavily indebted corporations not able to meet their defined-benefit obligations. As such, this invention and its ability to encourage employees to increase retirement savings is believed to be in the public good.

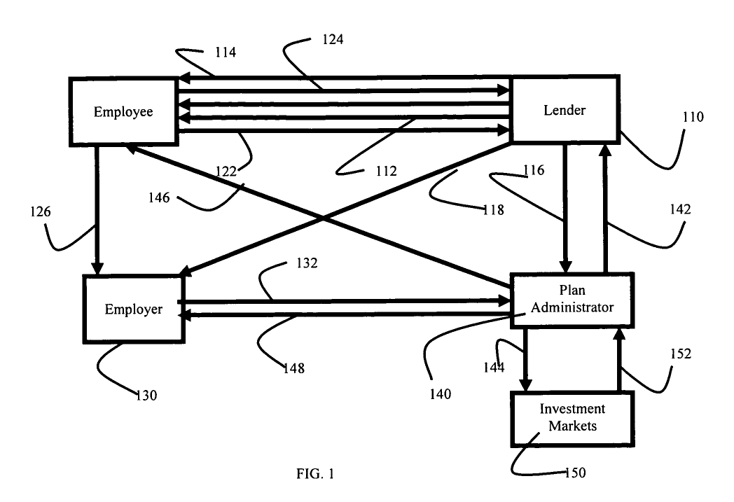

The concept of funding DC contributions through a lending vehicle should not be confused with loans based on DC balances. There is an active market in DC loans based on existing assets in a retirement account. These loans are offered by over three-quarters of 401(k) plans. They are not loans made to increase an individual's contribution to the plan, but rather to make liquid for a period of time a portion of his/her existing retirement investments. There are specific restrictions on the use of these funds as they can be used only in the event of a hardship or towards the purchase of a primary residence. The lending process for loans made in accordance with an embodiment of the invention is rather complex as it requires significant amounts of data specific to individuals (salary, self contribution percentages, limitations), credit underwriting (credit limits, term limits), plan data (plan rules and limitations), and government regulations. The marketing of these types of loans is significantly different from other consumer-lending products because of the involvement of data beyond credit-related information and key data collection requirements of various parties. Still the key component that is unique in the marketing of these loans as how they can be an inexpensive (even in some cases, free in the short term) method of funding retirement. A loan of this type may be marketed using the steps illustrated in FIG. 1.

In steps 112 and 118, a lender 110 markets a DC tax-advantaged loan to an employee 120 and an employer 130. The lender 110 also may market the loan to a plan administrator 140, as shown in step 116. The marketing would be designed to encourage participation in the program as a way to increase employee retirement savings and would use computer modeling to illustrate how tax savings can pay for the loan. In step 122 the employee 120 applies for a DC loan from lender 110. Once the lender 110 approves the loan (not shown), at step 124 the employee 120 selects a participation rate such as a percentage of salary and a share of contributions that will come from salary versus borrowed funds. At step 126, the employee/borrower chooses his/her contribution amount (% of salary) and investment choices relaying that information to the employer and plan administrator.

At step 132, the employer 130 makes periodic contributions (with other employee amounts) to the Plan Administrator 140 for the full amount of the employee contribution (the full amount being the combination of the amount withheld from salary, plus the amount of the loan for that period), withholding the full amount of the employee's contribution from his/her pay. At step 114, the Lender 110 sends funds for the borrowed amount of the contribution to the employee's bank account, making up for the loan amount which was withheld from the employee's paycheck and sent to the plan administrator in step 132. At step 144, the Plan Administrator invests the funds in investment securities 150 per the employee's designations.

At step 152, investment return data is received by the Plan Administrator 140 from the investment markets 150. The Plan Administrator 140 then reports the investment return data back to the employee 120, the lenders 110, and employer 130 at steps 142, 146, and 148.

The model for marketing of the tax-advantaged loans of the present invention provides for input of key variables and assumptions and calculates estimates of the amount of retirement savings that the individual can expect based on participating in the pension-loan program or by investing without a loan product.

The variables include (input in italics and underlined):
Enter Annual Salary $: 42,000
Enter Tax Filing Status: Single
Enter Current DC Participation Rate %: 3%
Current Annual Contribution: $1260
Enter Your Current Age: 26
Estimated Marginal Tax Rate: 27.5%
Enter Your Current DC Investments: $5000
Estimated Annual Return on Invested Assets: 8.0%
Estimated Increase in Earnings: 7.5%
Number of Years Borrowing: 5
Max Percent of Salary Willing to Borrow: 20%
Company Matching Percentage: 50%
Max Company Match (% of salary): 6%

Based on these variables and assumptions, the model calculates the expected total retirement savings and total contributions to the retirement plan, both gross and net of taxes, as a way to understand the value of participating in the pension lending program. The model uses spreadsheets of the types shown in FIG. 2.

This computer-based program illustrates the tax benefits inherent in the pension-loan program and provides marketers of the product an ability to communicate how such a program can benefit individual workers/employees. The computer-based model also illustrates how the loans can increase the amount of “free” money provided by employer matching of contributions. Because the loans increase employee contributions so they also increase employer contributions. It is also a tool that can be used in the marketing of the program to employers, plan administrators, and investors.

The model provides information on expectations of total retirement savings after a specified period of time and at selected retirement age. In the case of the standard model, the retirement age is 65. Using the assumptions above, an example of the model's predictions is shown in FIG. 2.

In the example shown in FIG. 2, the potential borrower is earning $42,000 per year and is ordinarily investing 3% of his earnings in a DC plan. In the case where he does not participate in the pension-loan program, he makes a total contribution (net of taxes) of $12,923 over 10 years and $207,599 (the first and third—“no loans”—columns) until retirement at age 65. Given the various assumptions (return on assets, increase in salary, etc), this individual will have retirement investments of $50,759 after 10 years and $1,611,061 at retirement.

The lending examples, the second and fourth columns, illustrate the power of the pension-loan program. Over the first 10 years, the difference in out-of-pocket cost to the individual is just $3,302 (rounded), which is the difference between the $12,923 he would have spent without the program and the $16,226 spent with the program, including increased tax savings and interest payments on the loans. This same $3,302 difference carries through retirement.

The difference in retirement savings, however, is dramatic. After 10 years, the individual has $147,336 in retirement savings (versus just $50,759 without the program) and at retirement (using the same assumptions) the total retirement nest egg is close to $2.6 million versus about $1.6 million without the lending program.

The total loan in this example is $48,790, which the model has assumed is repaid at the end of the loan period. Even with this repayment requirement, the loan program adds significant savings to the individual's retirement plan, adding a net benefit of $44,484 over 10 years and fully $919,729 at retirement. Interest on the loan must be paid to the lender. In this example, the amount of interest ($16,720) is almost completely offset by increased tax savings of $13,417. The cost of the loan is, therefore, minimized by the increase in tax savings.

Under the scenario presented, over the course of the individual's career he will contribute (from salary) a total of $286,343 under both scenarios. In the loan scenario, he contributes the additional borrowed amount of $48,790 and pays interest on that amount of $16,720. His return for this additional investment of $65,510 includes:
$13,417 in tax deferrals;
$3659 in additional company matching funds; and
$919,372 in additional asset appreciation (over and above the appreciation in the base scenario).

The computer-based model will be housed in the lender's technology center and will interface with various CPUs and databases both within the lending organization and, in most instances, within other organizations that are part of this invention process. For example, the lending database will interface with employer human resources systems (or their HR outsource payroll provider) for various data feeds such as salary/other compensation amounts, payroll cycles, confirmation of DC contributions made, continuing employment of participants, and other data elements. The system will also interact with those of various plan administrators to monitor contributions made to individual plans, plan assets and investments, and other data.

An embodiment of the invention includes a computer-based model for the calculation of individual cash flows (take-home pay) for individuals who participate in the program. Based on various assumptions and input of tax rates and other variables, the model produces estimated monthly, bi-weekly, or annual take-home pay based on participation in the pension-loan program. The computer can also be used to compare differences in cash flow were an employee to participate in the program versus not and provides information on the expected change in retirement savings (nest egg) based on the various cash flows and borrowing under the program.

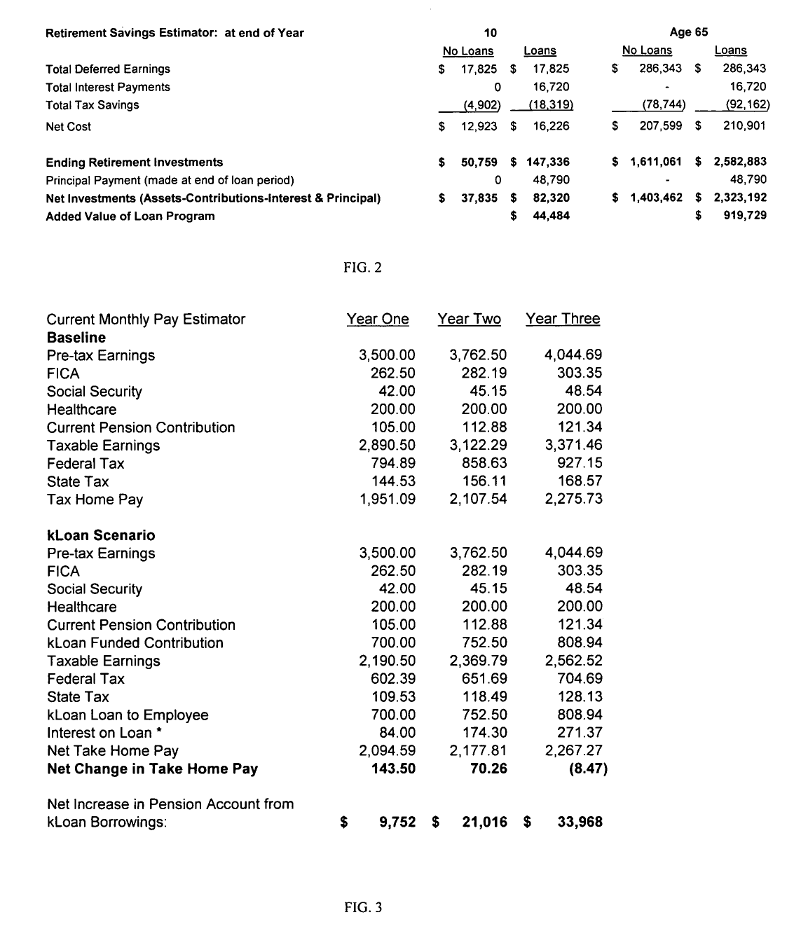

The model produces data such as that shown in FIG. 3 that can be used to illustrate the program to employees. In the example shown in FIG. 3, for the baseline (no participation in a pension-loan program) the individual expects to receive $1951.09/month in take-home pay during the first year, after taxes and contributions to medical and DC plan of 3% of salary. As salary increases, this amount grows to $2275.73/month in the third year.

In the borrowing scenario, where she borrows to increase the amount of contributions to the DC plan, the individual actually experiences an increase in take-home pay during the first two years of the program (that's because the interest rate on the loan is lower than her tax rate, so paying interest on a dollar is less cost than the savings of not paying taxes on that dollar). In this case, the individual experiences a net increase in take-home pay of $143.50 per month in the first year and $70.26 in the second. During the third year, when she pays interest on the total loan amount, which has been building during the first two years, take-home pay suffers somewhat to the rate of $8.47 per month.

Nevertheless, the increase in retirement savings illustrates, once again, how this is beneficial. During the first year, savings are $9,752 higher, $21,016 higher in the second year, and $33,968 higher in the third.

The model can be used using various scenarios and changes in assumptions that will allow the potential borrower to understand how different variables can be expected to affect his/her periodic take-home pay.

A preferred embodiment of the invention further has a computer-based process for credit underwriting that includes standard underwriting criteria and models (generally off-the-shelf) and combines them with information specific to the pension-loan product. The computer process includes information from an individual's employer that includes any company match in DC investing (most companies match employee funding in the programs up a certain level) and will also include general information about salary expectations for individuals. This information will be a powerful tool for the credit underwriting process. While it will not be a full proof way to estimate employee credit worthiness, because contribution amounts and ability to self-fund (pension investments) are highly dependent on the growth rate of salary, the information will be useful to the lender to understand the repayment timing (when the employee will no longer require funding) and will provide a range of expectations to check against an employee's estimated salary growth used in the base pension-lending model (under #1 above).

The invention includes the use of web-based computer systems to provide users (either directly at the web site of lenders, at internal “intranet” sites of employers, at plan administrators, or to any web site based on a “hot link” from one of these entities) with web-based modeling such as those in the examples found in FIG. 2 and FIG. 3. The web site will provide users with input screens where they may enter information as input variables (such as those found in paragraph 0024, above). The computer will then provide, instantly in an online environment, the results of the modeling effort illustrating individual expected results of participation in the pension-lending program.

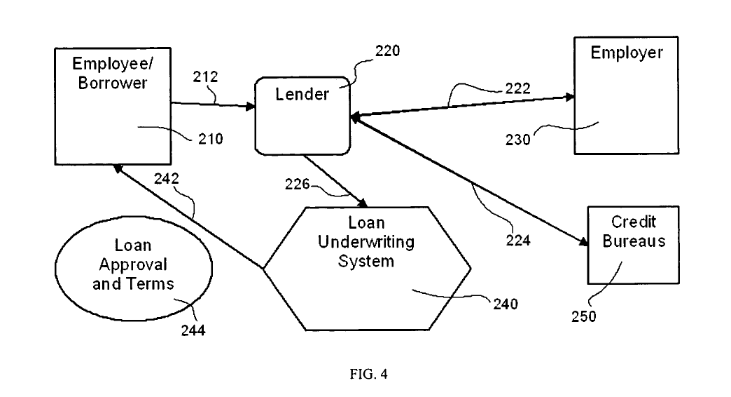

The underwriting process, shown in FIG. 4, includes input from employers as well as input from credit bureaus (which is standard for consumer-loan underwriting). Employee/borrower 210 applies 212 for the pension loan from a lender 220. The employee/borrower 210 provides standard credit application information (existing credit outstanding, social security number, salary, address, etc) and also provides expectations of salary escalation over the period of time for which a loan is requested. The application will also include timeframes for borrowing (number of years he/she would like to enhance his/her DC contributions) and the maximum percentage of salary he/she is looking to borrow in any given year.

This information is stored in an underwriting system and queries are sent to the perspective borrower's employer requesting confirmation of current salary and ranges for expected increases in salary for the title and tenure of the applicant. This information will not be shared with the applicant, but will be used to confirm how realistic the employee's expectations are as it has an impact on the amount of borrowing anticipated over the borrowing period. This is shown in step 222.

In step 224, the lender 220 queries credit bureaus 250 using borrower information, including social security number, to obtain credit reports and FICO (or other industry-standard credit scoring data) scores. This is standard practice in consumer credit. Information from both the employers query (step 222) and the credit bureaus (224) are fed to the Loan Underwriting System 240 in step 226.

Based on the combined input of the employee application, queries to employer and credit bureaus, the underwriting model provides an assessment of risk and calculates the amount of lending acceptable in the situation.

Assuming the loan program is approved, notification is sent to the employee/borrower 210 with terms of the loan and confirming the loan process at points 242 and 244. This approval is based on data and calculations embodied in the loan underwriting system 240

The invention includes the use of a computer and computer-based models to calculate employer benefits and expected costs of participation in the pension-loan program. The expectation is that employers will be willing participants in the pension-loan program, marketing it internally and encouraging participation by employees once they understand the value that it provides to their employees and how it encourages pension investment, better preparing employees for retirement. The other benefit will be to reduce company plans' susceptibility to hitting limitations in terms of higher-compensated employees reaping an unbalanced share of the plan's benefits (there are various tests that organizations must undertake to ensure the plans are not unjustly benefiting certain classes of workers). By encouraging participation and savings among those who otherwise would not invest or would not invest fully, management (those who tend to be among the highly compensated) will reduce their risk of limitations of their own pension contributions.

The cost to employers is real and the model will help them understand this cost. Because many plans contribute to employee DC plans, ordinarily through a matching formula, increases in participation and rates of withholdings, will increase the amount of matching. As a result, the employer can be expected to experience increased costs as more employees participate and at increased contribution rates. The model will help them estimate this increase to allow for better planning.

The computer model provides a marketing and administration module for use in discussions with employers. The lender will input selected data from employers, including but not limited to:
Number of employees
Number of eligible employees
Current participation rates
Current salary levels
Specific employee information
   a. Salary
   b. Age
   c. Participation levels
Plan information
   a. Administrator
   b. Limitations
   c. Matching provisions

Based on this and other information, the computer can generate scenarios for marketing and other uses in discussions with potential employer plan participants. Based on these data, the program can calculate the amount of participant money being invested annually relative to the IRS limitations and can estimate the amount of money and tax savings being “left on the table”. The computer will have generated experience with other employers and will store and categorize this information, including data on companies in similar industries. Using these experiences, the computer will estimate the percentage of employees who would likely participate in the pension-loan program, along with resulting contribution amounts. Employers can also understand what the expected increase in matching funding would be for their program. Like the employee modeling modules, the computer-based models for employer and plan administrator marketing will be available through an online environment. The models will allow for online input of key variables and will provide employers and administrators with information on expectations of experiences with participating in the pension-lending program.

The invention includes a computer-based process that administers the lending product. Based on various inputs, the computer-based process calculates (by individual participant in the program) the available amount of the loan during any given payroll period, calculates the loan amount, initiates funding, books the loans, provides for recordkeeping of loan balances by borrower and by employer group, and calculates interest and fees based on the loan balances.

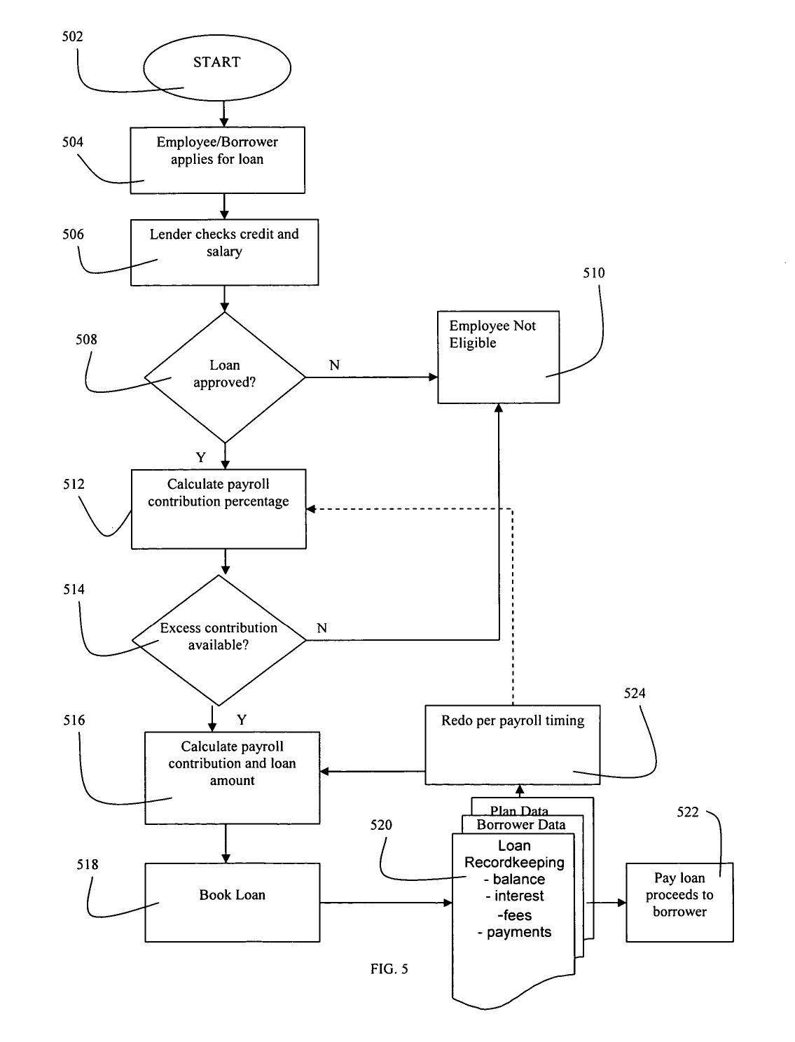

The flow chart in FIG. 5 illustrates the process. The loan process starts at step 502. At step 504, the Employee/borrower 210 applies for the pension-based loan. The Lender 220 confirms the Employee/borrower's credit and salary/DC plan information with employer and credit agencies at step 506. If the loan is rejected at step 508, the process ends with the employee being rejected at step 510. If the loan is approved at step 508, the Lender calculates the Employee/borrower's current payroll contribution percentage and the maximum contribution allowed by law at step 512. At step 514, a determination is made as to whether a sufficient excess contribution is available to justify entry into the loan program. If no excess contribution is available, or if an insufficient excess contribution is available, the employee/borrower is advised that they are not eligible for the loan at step 510.

If excess contribution is available at step 514, the amount of loan to be made based on a percent contributed via employee earnings, allowed maximum contribution allowed by law, and excess of allowable versus employee contributed (subject to credit and other constraints) is calculated at step 516. This calculation of the amount of the loan to be made may be repeated periodically during the employee/borrower's participation in the program (based on the frequency of payroll for individual employees).

If excess contribution is available at step 514, the system calculates that amount that is available by determining the difference between the current IRS limit and the current contribution percentage of the employee's salary at step 516. The system then calculates the amount of loan to be made for that pay period. At step 518 and 522, respectively, the system books the loan and initiates payment of the proceeds of the loan to the employee, who will have that same loan amount withheld from payroll on a pre-tax basis for investment in the DC plan. The loan is booked in the recordkeeping system at step 520 with the new loan added to the existing balances (net of payments) for the borrower. The recordkeeping system collects and stores various information on the loans, borrowers, plans, and other records, including, but not limited to: loan recordkeeping (balances, interest rates, terms, payment history, and fees); plan data (plan names for employees, plan administrators, contact information, plan rules and plan investments); and borrower data (borrower name, address, email, other, credit information, investments, employers, current salary, current contribution, loan term and other limitations).

The recordkeeping system makes various loan-related calculations, including but not limited to: outstanding balances, interest charges, fees and other charges, and payments received. The recordkeeping system additionally generates periodic reports to be sent to borrowers showing outstanding balances and interest/fee charges due. The recordkeeping system tracks periodic payroll timing and restarts the process based on the periodicity of payroll for individual borrowers. At step 524, the system redoes the calculations and payments per payroll timing. For each payroll period, the system may return to 516 or 512 depending on the loan approvals used and/or changes to the employees' contributions, salary, etc. The recordkeeping system houses significant amounts of data on various elements of the lending program, including information on individual borrowers and their respective DC, IRA or other retirement plans. Among the various data that resides in the recordkeeping, the system includes tracking individual loan amounts, interest and other charges, payments, records of plan rules, information on individuals, employers and plan administrators and significant levels of other individual and plan/employer-related data. The various calculations involve a series of variables critical to the approval, lending, loan and investment tracking, and other recordkeeping services. Further, the system automates the lending process coincident with payroll periods of individual participants.

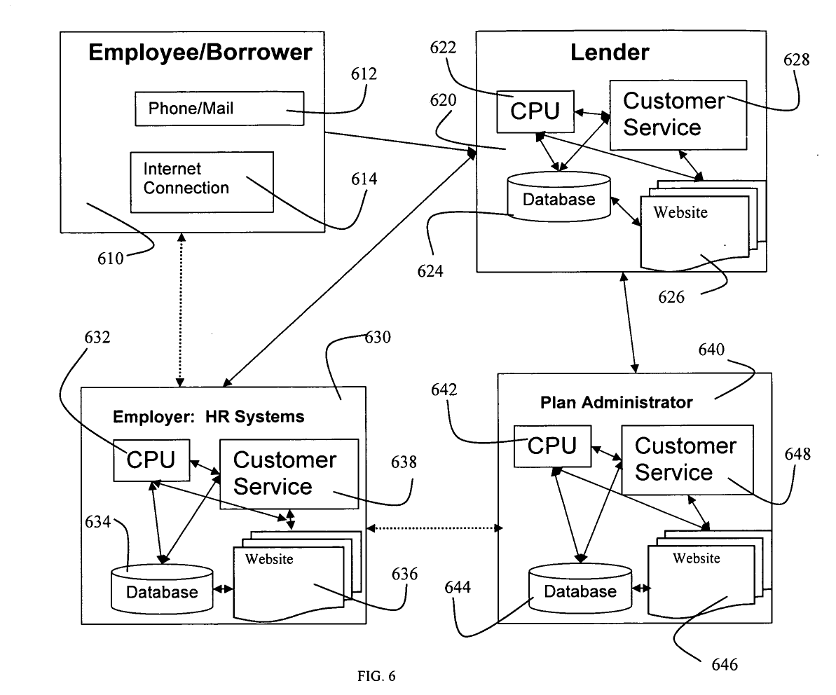

The recordkeeping system and other systems developed as part of the invention along with various interfaces with other systems are represented in one likely form in FIG. 6. In this schematic, the lender 620 will have various computer systems, including databases 624 to store key employee/borrower, employee, plan and other data as well as customer service and website systems 628, 626 that interact internally (within the lending organization) and, via various interfaces, with other participants in the program. The databases may be stored in any known manner, such as in RAM memory, on hard disk drives, magnetic tapes, and the like. Plan Administrator 640 will have various computer systems, including CPU 642, databases 644, customer service 648 and websites 646. Employer 630 likewise may have various computer systems including CPU 632, databases 634, customer service 638, and websites 636. FIG. 6 illustrates how an employee/borrower 610 can interact with the lender 620 and the pension-lending databases, recordkeeping, and processes via internet 614, phone or mail 612. The lender's systems will also interface with those of both the employer 630 and plan administrator 640 for each participant in the program. The information flows from the employer 630 and plan administrator 640 to the lender 610 includes information critical to the recordkeeping, loan processes, and other processes that are part of the invention.

Employers will feed to the lender recordkeeping system information specific to employees including, but not limited to: salary, other compensation (to account for non-salary compensation against which employers will withhold pension contributions), timing of payroll, adjustments to salary, changes in employee status, changes in employee personal information (e.g., name, address, phone), confirmation of investment of contributions to the plan, and other items. Plan administrators will provide the lender with information about individual DC investments, including asset classes, returns, and concentrations of assets. Both employers and plan administrator systems will also interact with the core lender systems to allow for employee/borrowers to make changes to their withholdings, loan amounts, automated repayment via payroll, and other loan-related changes and updates to the lender system. Employees can also use existing connections (shown with dotted lines, these existing connections include the employee choice of participating in the plan, percentage of salary, investment choices, and other items) to link to lender sites and customer service, make loan product changes, collect information on balances, and other items. These existing interfaces also include information flows regarding account balances, rules changes, and others.

When combined with the re-calculations performed each pay period in steps 516 and 524 of FIG. 5, these interfaces and exchanges of information between the lender, plan administrator and employer create great flexibility for the employee/borrower. For example, consider an employee/borrower whose pay varies from pay period to pay period because the employee is paid based upon an annual salary plus overtime pay, bonuses, or commissions. In a pay period in which the employee has no overtime pay, bonuses or commissions, the employee could borrow the entire amount of the defined contribution, thereby receiving the tax savings and employer matching associated with that contribution and still receive the maximum amount of take-home pay based upon their salary. In pay periods in which the employee receives overtime pay, bonuses or commissions, the system may calculate a different loan amount based upon user preferences. For example, the user could elect to receive as a minimum the take-home pay based upon their salary and use to extra money from the overtime, bonuses, or commissions to make their contribution for that pay period, pay interest on any existing loan in one exists, or even pay back principal on prior loans.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A system for administering a computer-based loan program comprising:
a database of information on employees, said database comprising:
information of a specific employee's pay;
information of a defined contribution plan;
said specific employee's preferences for contributions to said defined benefit plan; and
said specific employee's preferences for receiving loans;
means for updating said information of said specific employee's pay at periodic intervals;
means for calculating at each periodic interval an amount of a loan based upon said information of a defined contribution plan, said specific employee's pay for a particular periodic interval, said specific borrower's preferences for contributions to said defined benefit plan, and said specific borrower's preferences for receiving a loan;
means for withholding from said employee's pay for a particular periodic interval said calculated loan amount for said particular periodic interval;
means for contributing said withheld amount to said defined contribution plan; and
means for providing said loan amount to said employee.

2. A system according to claim 1, further comprising means for performing various loan tracking and loan administration processes.

3. A system according to claim 2 wherein said means for performing various loan tracking and load administration processes comprises means for tracking at least one of balances, interest due, fees, and payments.

4. A system according to claim 3 further comprising means for reporting information to said employee wherein said reported information comprises a tax-savings associated with a loan amount.

5. A system according to claim 1 further comprising means for withholding from said employee's pay for second particular interval an amount to re-pay at least a portion of a prior loan amount.

6. A system according to claim 1 wherein said means for providing said loan amount for said particular interval to said employee comprises direct depositing said loan amount into a bank account of said employee.

7. A system according to claim 1 wherein said periodic intervals comprise payroll periods.

8. A method of administering a loan program in a system comprising a CPU and a database of information of a defined contribution plan, employee pay information, employee preferences for contributions to said defined benefit plan, and employee preferences for receiving loans, comprising the steps of:
updating said database with information of a specific employee's pay information for a first pay period;
calculating a loan amount for said first pay period based upon said information of a defined contribution plan, said specific employee's pay information for said first pay period, said specific employee's preferences for contributions to said defined benefit plan, and said specific employee's preferences for receiving a loan;
withholding from said employee's pay for said first pay period said calculated loan amount for said first pay period;
contributing said withheld amount for said first pay period to said defined contribution plan;
providing said loan amount for said first pay period to said employee;
updating said database with information of a specific employee's pay information for a second pay period;
calculating a loan amount for said second pay period based upon said information of a defined contribution plan, said specific employee's pay information for said second pay period, said specific employee's preferences for contributions to said defined benefit plan, and said specific employee's preferences for receiving a loan;
withholding from said employee's pay for said second pay period said calculated loan amount for said second pay period;
contributing said withheld amount for said second pay period to said defined contribution plan;
providing said loan amount for said second pay period to said employee.

9. A method of administering a loan program in accordance with claim 8 wherein said loan amount for said second pay period differs from said loan amount for said first pay period.

10. A method of administering a loan program in accordance with claim 9 wherein said loan amount for said second pay period is zero.

11. A method according to claim 9 further comprising the steps of:
calculating a loan repayment amount for said second pay period based upon said information of a defined contribution plan, said specific employee's pay information for said second pay period, said specific employee's preferences for contributions to said defined benefit plan, said specific employee's preferences for receiving a loan and preferences of said specific employee for repaying a loan.

12. A method for computer-based marketing of a loan program, said method comprising the steps of:
providing at least one of a loan consumer, a plan administrator, and an employer with an interface to a computer-based loan program marketing system, said computer-based loan program marketing system comprising a processor and a memory;
receiving input information relating to a loan consumer through said interface;
storing said input information relating to a loan consumer in said memory;
calculating tax-savings resulting from increased individual retirement savings contributions afforded by participation in said loan program; and
displaying advantages of said loan program based upon said tax-savings.

13. A method for computer-based marketing of a loan program in accordance with claim 12 wherein said providing step comprises providing a web-based system for inputting and displaying information.

14. A method according to claim 12 further comprising the steps of:
calculating cash-flow for said loan consumer using a computer model that provides cash flow estimates for individual pension investors and borrowers illustrating day-to-day cash impact of lending program; and
creating a model for running various cash flow scenarios depending on individual participant's assumptions.

15. A method according to claim 12 further comprising the step of generating a computer-based underwriting model comprising:
standard credit-scoring (FICO scores) and other standard underwriting; and
information from employees (confirmed within broad ranges by employers) regarding future earnings expectations.

16. A method according to claim 12, wherein said displaying step comprises:
displaying a computer model for employers to illustrate benefits to employees as well as cost to the organization, if any, of participating in the pension-lending program;
displaying a computer model for marketing said loan program within various employee groups;
displaying a model for calculating outstanding balances on loans for comparison to investment balances; and
displaying a model of lending programs and information on employers groups administered and forecasting model of participant contributions.
